(19) United States
(12) Patent Application Publication
(10) Pub. No.: US 2023/0226672 A1
(43) Pub. Date: Jul. 20, 2023

(54) WRENCH

(71) Applicant: KYOTO TOOL CO., LTD., Kyoto-shi (JP)

(72) Inventors: Shunsuke ONISHI, Kyotanabe-shi (JP); Shiro YORITOMI, Hirakata-shi (JP)

(21) Appl. No.: 18/052,686

(22) Filed: Nov. 4, 2022

(30) Foreign Application Priority Data
Jan. 14, 2022 (JP) 2022-004149

(51) Int. Cl. B25B 23/16

(52) U.S. Cl. CPC B25B 23/16; B25B 13/462

(57) ABSTRACT

In order to prevent the deformation and damage of a handle while reducing the weight of a wrench, a wrench includes a head provided at a front end portion and a handle to be gripped by a user, in which the handle is formed with lightening portions and a remaining portion formed around the lightening portions, and the remaining portion includes a first inclined rib intersecting an extending direction Y of the handle and a second inclined rib intersecting the extending direction Y of the handle and also intersecting the first inclined rib.

### BACKGROUND

### Technical Field

The present invention relates to a wrench.

### Related Art

In some conventional wrenches, as described in S52-150094 U, lightening portions are formed by penetrating a handle to be gripped by a worker to reduce the weight.

Here, as a result of analyzing the stress on a wrench without being lightened during work, it can be seen that a stress concentration portion does not appear on the handle and the force applied by the hand of the worker is dispersed as illustrated in FIG. 8. Note that in FIG. 8, a whiter portion indicates that a larger stress is applied.

However, depending on the positions or sizes of the above-described lightening portions, a stress concentration portion may occur on the handle, and in that case, the handle may be deformed or damaged. Conversely, sufficient weight reduction may be unachievable due to fear of deformation or damage of the handle.

### PRIOR ART DOCUMENT

### Patent Document

JP S52-150094 U

### SUMMARY

Therefore, a main object of the present invention is to prevent deformation, damage, and the like of the handle while reducing the weight of the wrench.

That is, a wrench according to the present invention includes a head provided at a front end portion and a handle to be gripped by a user, in which the handle is formed with a lightening portion and a remaining portion formed around the lightening portion, and the remaining portion includes a first inclined rib intersecting an extending direction of the handle, and a second inclined rib intersecting the extending direction of the handle and also intersecting the first inclined rib.

With the wrench configured as described above, the force applied to the handle by the hand of the worker can be dispersed by the first inclined rib and the second inclined rib that intersect each other, so that deformation, damage, and the like of the handle can be prevented while reducing the weight by forming the lightening portion. Note that a specific analysis result regarding the stress applied to the handle will be described below.

A more specific embodiment may be an aspect in which the handle further includes a frame constituting an outer frame, and each of the first inclined rib and the second inclined rib includes a root portion on a front end side and a root portion on a rear end side connected to the frame.

With this configuration, the first inclined rib and the second inclined rib intersect each other inside the frame, and the periphery of these inclined rib is lightened, so that the lightening portion can be large, and the wrench can be lighter.

As described above, since the force applied by the hand of the worker is dispersed through the remaining portion so as to suppress the stress concentration on the remaining portion, the remaining portion may be thinner than the surrounding frame.

Thus, it is preferable that a length of the remaining portion between a surface facing away from an object to be tightened and a back surface opposite to the surface be smaller than a length of the frame between a surface facing away from the object to be tightened and a back surface opposite to the surface.

With this configuration, deformation and damage of the handle are prevented by dispersing the force described above, and the length of the remaining portion between the surface facing away from the object to be tightened and the back surface opposite to the surface is smaller than the length of the frame between the surface facing away from the object to be tightened and the back surface opposite the surface. This forms a level difference between the remaining portion and the frame, so that it is possible, for example, to leave a forged skin on the remaining portion to make the shape of the remaining portion conspicuous.

The lightening portion is surrounded by the frame, the first inclined rib, and the second inclined rib, and is wider on a front end side than on a base end side.

This makes the handle wider on the front end side than on the base end side to improve the ease of gripping.

It is preferable that in one or both of the first inclined rib and the second inclined rib, a root portion on a rear end side be longer than a root portion on a front end side.

With such a configuration, since the root portion on the rear end side close to the portion gripped by the worker is longer, the force from the gripping hand can be received by a wider range of the handle and dispersed, so that stress concentration on the handle can be further suppressed.

A way of using the wrench includes, for example, quick turning with gripping the head at a low load. Considering this situation, the weight reduction by the above-described lightening portion may make the gripping of the head slightly less stable than a heavy wrench.

Thus, it is preferable that the head include a tapered surface formed between a surface facing away from the object to be tightened and an outer surface.

This can improve the ease of gripping of the head.

Furthermore, it is preferable that the head include at least three outer flat surfaces that are flat and constitute the outer surface.

In this case, for example, the head gripped at the time of the quick turning described above can be easily maintained in a horizontal posture, and stability can be further improved.

Another way of using the wrench includes quick turning with gripping the neck at a medium load. Considering this situation, the weight reduction by the above-described lightening portion may make the gripping of the neck slightly less stable than a heavy wrench.

Thus, it is preferable that an outer surface of the neck connecting the head and the handle be a surface parallel to a rotation axis of the head.

This can improve the ease of gripping of the neck.

### ADVANTAGEOUS EFFECTS OF INVENTION

According to the present invention configured as described above, deformation and damage of the handle can be prevented while reducing the weight.

### BRIEF DESCRIPTION OF DRAWINGS

FIG. 1 is a perspective view illustrating a configuration of a wrench according to an embodiment of the present invention;

FIG. 2 is a schematic view illustrating a configuration of the wrench according to the embodiment;

FIG. 3 is a partially enlarged view in which a head of the wrench according to the embodiment is enlarged;

FIG. 4 is a partially enlarged view in which a handle of the wrench according to the embodiment is enlarged;

FIG. 5 is analysis data obtained by analyzing stress applied to the wrench according to the embodiment;

FIG. 6 is a perspective view illustrating a configuration of a wrench according to another embodiment;

FIG. 7 is a schematic view illustrating a configuration of a wrench according to the other embodiment; and

FIG. 8 is analysis data obtained by analyzing stress applied to a normal wrench.

### DETAILED DESCRIPTION

Hereinafter, an embodiment of a wrench according to the present invention will be described with reference to the drawings.

The wrench according to the present embodiment is a tool used for tightening an object to be tightened such as a bolt and loosening it. Note that a ratchet handle will be described as an example of the wrench, but various tools such as a spanner, an eyeglass wrench, and a monkey wrench may be used.

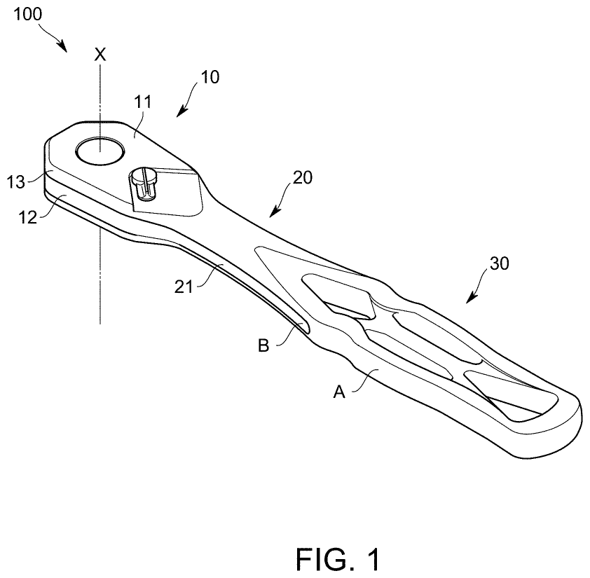

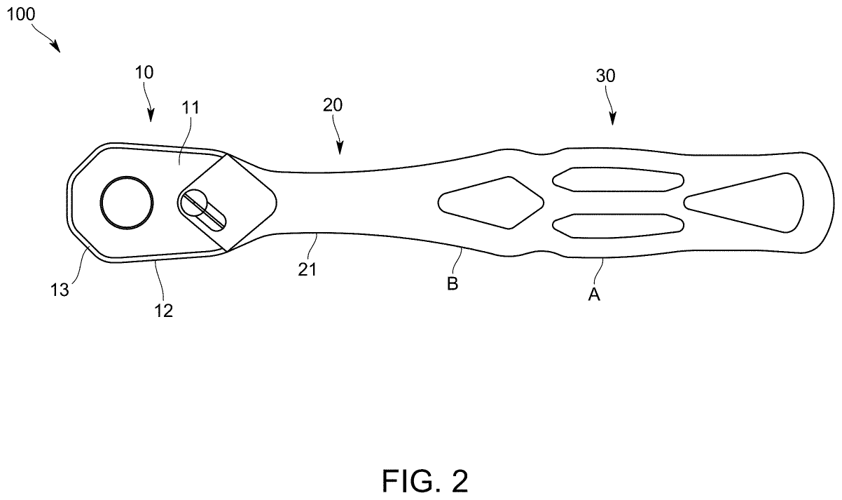

As illustrated in FIGS. 1 and 2, a wrench 100 includes a head 10, a neck 20, and a handle 30 in this order from the front end side toward the rear end side, and is configured such that the tightening direction can be switched between clockwise and counterclockwise directions. However, it is not necessary to be able to tighten bi-directionally, and the tightening direction may be only one direction.

The head 10 engages with the object to be tightened directly or via a separate member such as a socket, and is, for example, a portion to be gripped by a user during work at a low load.

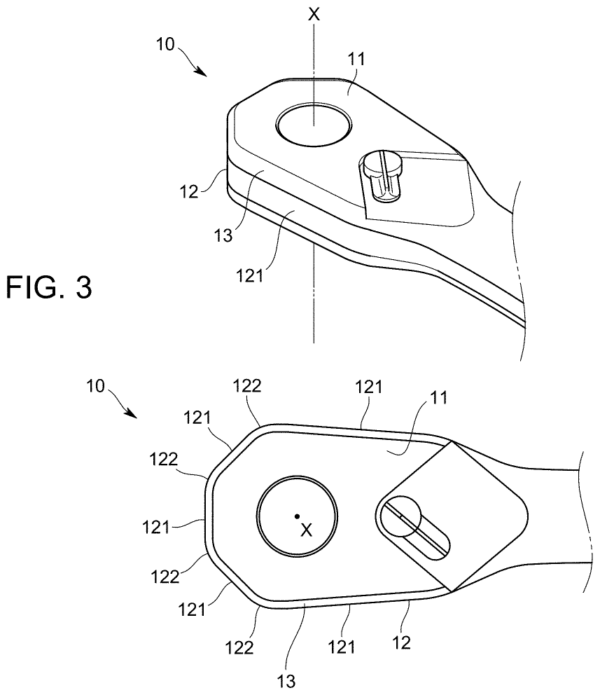

For easier gripping, the head 10 of the present embodiment includes a tapered surface 13 formed between a surface 11 facing away from the object to be tightened (hereinafter, also referred to as upper surface 11) and an outer surface 12 as illustrated in FIG. 3. The tapered surface 13 is a flat surface inclined at a predetermined angle with respect to a rotation axis X of the head 10, and is continuously formed along the outer edge of the upper surface 11.

As illustrated in FIG. 3, the head 10 further includes at least three outer flat surfaces 121 that are flat and constitute the outer surface 12. The outer flat surfaces 121 are flat surfaces along the rotation axis X of the head 10, in other words, surfaces parallel to the rotation axis X of the head 10. The outer flat surfaces 121 are provided on positions corresponding to sides of a polygon in a top view. Here, the outer flat surfaces 121 are provided on positions corresponding to five of the six sides of a hexagon, and the outer flat surfaces 121 adjacent to each other are smoothly connected via one of curved surfaces 122 interposed therebetween.

The neck 20 is interposed between the head 10 and the handle 30 to connect them, and is specifically a constriction located rearward of the head 10, and is, for example, a portion to be gripped by a user during work at a medium load.

Referring FIGS. 1 and 2 again, in the neck 20 of the present embodiment, at least a part of an outer surface 21 is a flat surface along the rotation axis X of the head 10 for easier gripping. The outer surface 21 is partially curved along a direction from the front end side toward the rear end side of the wrench 100, and is partially flat.

The handle 30 is a portion to be gripped by a user, and is a portion to be gripped by a user during work at a high load or during work such as final tightening.

As illustrated in FIGS. 1 and 2, the handle 30 of the present embodiment includes a portion A to be gripped in the palm, and a portion B to which the thumb is set. The portion A has a round shape that is rounded, and the portion B is a flat surface that is flat along the rotation axis X of the head 10, in other words, a surface parallel to the rotation axis X of the head 10.

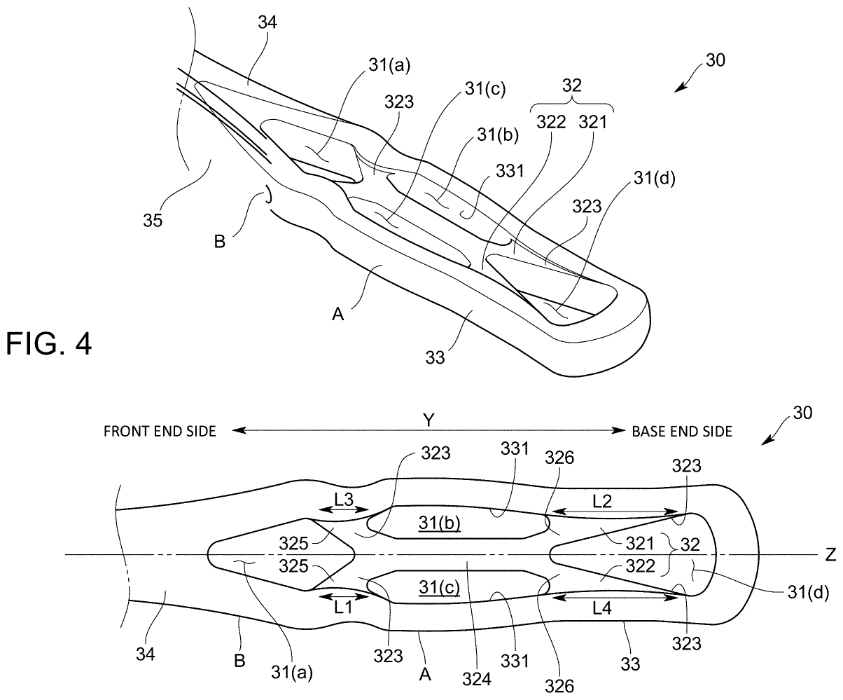

Additionally, as illustrated in FIG. 4, the handle 30 are formed with lightening portions 31 and a remaining portion 32 formed around the lightening portions 31.

More specifically, the handle 30 includes a frame 33 constituting the outer frame, and the lightening portions 31 are formed at a plurality of positions inside the frame 33, and the remaining portion 32 is provided so as to partition the lightening portions 31.

The lightening portions 31 are through holes formed by penetrating the handle 30 from a surface 34 facing away from the object to be tightened of the handle 30 (hereinafter, also referred to as upper surface 34) to a back surface 35 opposite to the surface 34. However, a part or all of the lightening portions 31 may be recessed portions that are recessed so as to form a bottom portion without penetrating the handle 30.

The remaining portion 32 is formed to be thinner than the frame 33, in other words, the length of the remaining portion 32 between the upper surface 34 and the back surface 35 is smaller than the length of the frame 33 between the upper surface 34 and the back surface 35. Accordingly, a level difference is formed between the remaining portion 32 and the frame 33. According to such a configuration, for example, the appearance (color, gloss, or the like) of the frame 33 in a top view may be different from the appearance (color, gloss, or the like) of the remaining portion 32 in a top view.

The remaining portion 32 includes a first inclined rib 321 intersecting an extending direction Y of the handle 30 and a second inclined rib 322 intersecting the extending direction Y of the handle 30 and also intersecting the first inclined rib 321.

The remaining portion 32 of the present embodiment has a substantially X shape in top view and has a symmetrical shape with a center line Z along the extending direction Y of the handle 30 as an axis of symmetry.

In each of the first inclined rib 321 and the second inclined rib 322, a root portion 323 on the front end side and a root portion 323 on the rear end side are connected to the frame 33, and more specifically, are connected to an inner surface 331 of the frame 33.

According to such a configuration, in the first inclined rib 321, a length L2 of the root portion 323 on the rear end side along the extending direction Y is longer than a length L1 of the root portion 323 on the front end side along the extending direction Y.

Furthermore, in the second inclined rib 322, a length L4 of the root portion 323 on the rear end side along the extending direction Y is longer than a length L3 of the root portion 323 on the front end side along the extending direction Y.

More specifically describing the first inclined rib 321 and the second inclined rib 322, each of these inclined ribs includes a shared element 324 that is provided at a position where the inclined ribs intersect each other and is shared with each other, a front-end-side oblique element 325 provided on the front end side with respect to the shared element 324, and a rear-end-side oblique element 326 provided on the rear end side with respect to the shared element 324.

In this embodiment, the shared element 324 extends along the extending direction Y of the handle 30, through which the center line Z along the extending direction Y of the handle 30 passes. Note that the remaining portion 32 of the present embodiment has a bilaterally symmetrical shape with the center line Z as a symmetry axis.

The front-end-side oblique elements 325 extend from predetermined positions in the frame 33 on the front end side with respect to the shared element 324 toward the front end portion of the shared element 324, and extend in a direction intersecting the extending direction Y of the handle 30.

The rear-end-side oblique elements 326 extend from predetermined positions in the frame 33 on the rear end side with respect to the shared element 324 toward the rear end portion of the shared element 324, and extend in a direction intersecting the extending direction Y of the handle 30.

According to such a configuration, the lightening portions 31 includes a first lightening portion 31a located on the front end side with respect to the shared element 324, a second lightening portion 31b and a third lightening portion 31c located on both left and right of the shared element 324, and a fourth lightening portion 31d located on the rear end side with respect to the shared element 324 are provided.

Here, the first lightening portion 31a has a substantially quadrangular shape in a top view, and has a shape in which an angle formed at the corner portion on the front end side is smaller than an angle formed at the corner portion on the rear end side.

The second lightening portion 31b and the third lightening portion 31c are surrounded by the frame 33, the first inclined rib 321, and the second inclined rib 322, and provided at positions to be accommodated in a palm gripping the handle 30. They have an elongated shape in a top view, and are wider on the front end side than on the base end side.

Here, the fourth lightening portion 31d has a substantially triangular shape in a top view, and its shape has an apex that is toward the front end side.

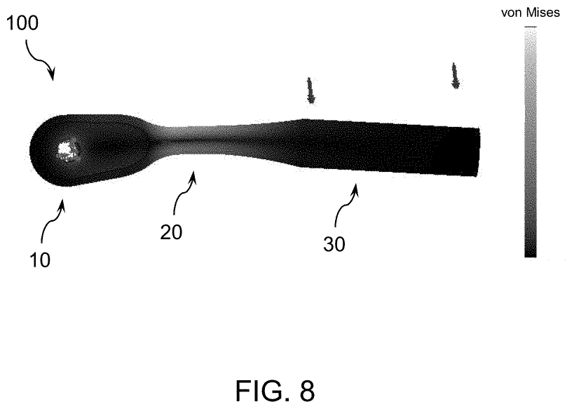

Here, as described in the related art, the analysis result illustrated in FIG. 8 is obtained by analyzing the stress on a wrench without being lightened during work, and it can be seen that a stress concentration portion does not appear on the handle 30 and the force applied by the worker is dispersed.

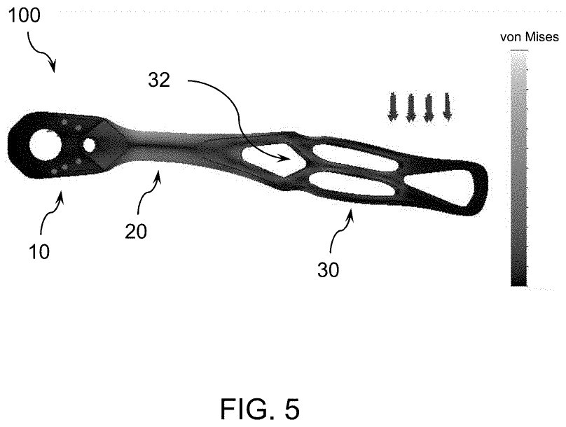

On the other hand, the analysis result illustrated in FIG. 5 is obtained by analyzing the stress on the wrench 100 of the present embodiment during work.

As can be seen from this analysis result, although the lightening portions 31 are formed in the handle 30, a stress concentration portion does not appear on the handle 30 similarly to the configuration illustrated in FIG. 8, and the force applied by the worker can be dispersed.

In FIGS. 5 and 8, a whiter portion indicates that a larger stress is applied.

According to the wrench 100 configured as described above, the force applied by the hand of the worker can be dispersed by the first inclined rib 321 and the second inclined rib 322 that intersect each other, and deformation and damage of the handle 30 can be prevented, while reducing the weight by forming the lightening portions 31.

In addition, since the root portion 323 on the front end side and the root portion 323 on the rear end side of each of the first inclined rib 321 and the second inclined rib 322 are connected to the frame 33, and the remaining portion 32 has a substantially X shape in a top view, lightening portions can be large, and the wrench 100 can be lighter, accordingly.

Furthermore, the length of the remaining portion 32 between the upper surface 34 and the back surface 35 is smaller than the length of the frame 33 between the upper surface 34 and the back surface 35, in other words, the remaining portion 32 is thinner than the frame 33. Accordingly, the weight of the handle can be further reduced due to the thinness while preventing the deformation and damage of the handle by dispersing the force.

Furthermore, since the remaining portion 32 is thinner than the frame 33, a level difference is formed therebetween, so that, for example, a forged skin can be left in the remaining portion 32, and the shape of the remaining portion 32 can be made conspicuous.

Furthermore, the second lightening portion 31b and the third lightening portion 31c are wider on the front end side than on the base end side. This makes the handle wider on the front end side than on the base end side, and improves the ease of gripping.

Furthermore, in each of the first inclined rib 321 and the second inclined rib 322, the root portion 323 on the rear end side is longer along the extending direction Y of the handle 30 than the root portion 323 on the front end side, and the root portion 323 on the rear end side is close to a portion gripped by the worker. Accordingly, the force from the gripping hand can be received by a wider range of the handle and dispersed, so that stress concentration on the handle can be further suppressed.

Furthermore, since the flat surfaces are provided on various positions of the head 10 and the neck 20, it is possible to improve the ease of gripping of the head 10 and the neck 20, and to secure the stability of works at a low load or medium load while reducing the weight.

Note that the present invention is not limited to the above embodiment.

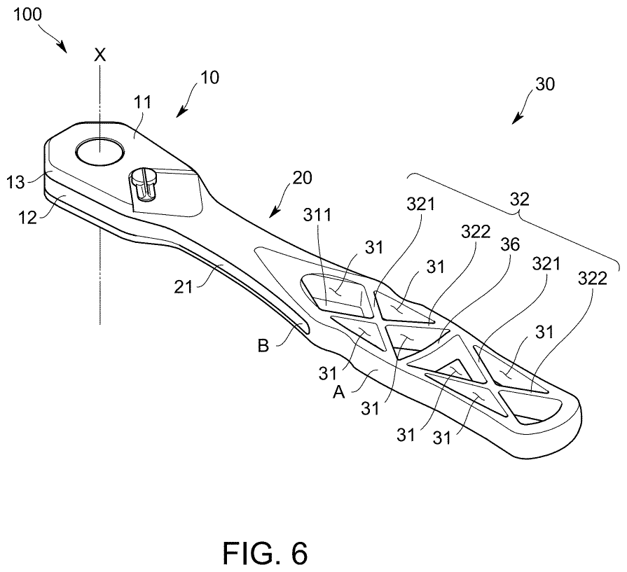

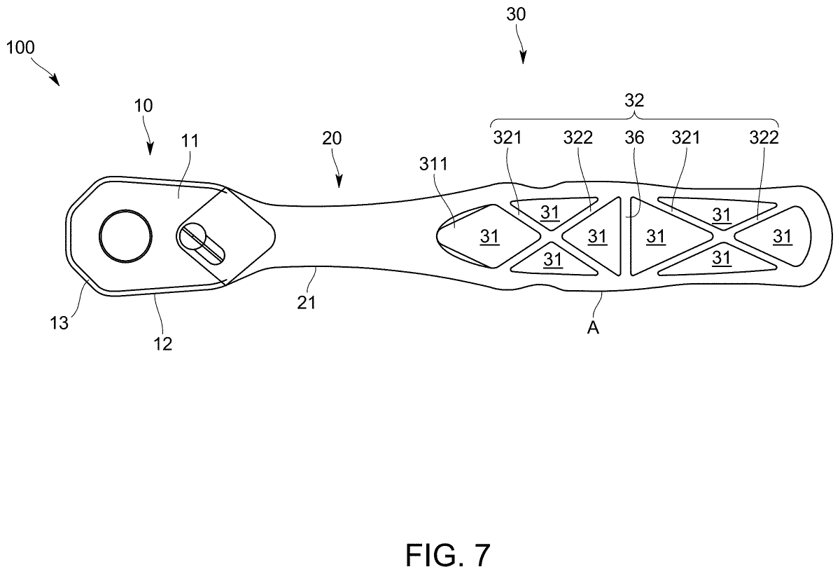

For example, in the wrench 100 according to the present invention, as illustrated in FIGS. 6 and 7, a remaining portion 32 may have a plurality of first inclined ribs 321 and a plurality of second inclined ribs 322.

With such a configuration, the number of brace portions formed by the first inclined ribs 321 and the second inclined ribs 322 increases, the force dispersion paths can be increased accordingly, and the deformation and damage of the handle 30 can be more reliably prevented.

In addition, at least one crossing rib 36 orthogonal to the extending direction Y of the handle 30 may be included.

Furthermore, as described in the above embodiment, the lightening portions 31 may be recessed portions having a bottom surface 311 as illustrated in FIG. 6.

Furthermore, for example, if the wrench 100 has only one tightening direction, the remaining portion 32 may have an asymmetric shape with respect to the center line Z along the extending direction Y of the handle 30.

As an example of a specific shape in this case, in only one of the first inclined rib 321 and the second inclined rib 322, the root portion 323 on the rear end side is longer than the root portion 323 on the front end side.

Furthermore, the present invention is not limited to the above embodiments, and it goes without saying that various modifications can be made without departing from the gist thereof.

### LIST OF REFERENCE CHARACTERS

100 wrench

10 head

20 neck

30 handle

31 lightening portion

32 remaining portion

33 frame

321 first inclined rib

322 second inclined rib

What is claimed is:

1. A wrench comprising:
a head provided at a front end portion; and
a handle to be gripped by a user,
wherein
the handle is formed with a lightening portion and a remaining portion formed around the lightening portion, and
the remaining portion includes
a first inclined rib intersecting an extending direction of the handle, and
a second inclined rib intersecting the extending direction of the handle and also intersecting the first inclined rib.

2. The wrench according to claim 1, wherein
the handle further includes a frame constituting an outer frame, and
each of the first inclined rib and the second inclined rib includes a root portion on a front end side and a root portion on a rear end side connected to the frame.

3. The wrench according to claim 2, wherein a length of the remaining portion between a surface facing away from an object to be tightened and a back surface opposite to the surface is smaller than a length of the frame between a surface facing away from the object to be tightened and a back surface opposite to the surface.

4. The wrench according to claim 2, wherein the lightening portion is surrounded by the frame, the first inclined rib, and the second inclined rib, and wider on a front end side than on a base end side.

5. The wrench according to claim 1, wherein in one or both of the first inclined rib and the second inclined rib, a root portion on a rear end side is longer than a root portion on a front end side.

6. The wrench according to claim 1, wherein the head includes a tapered surface formed between a surface facing away from an object to be tightened and an outer surface.

7. The wrench according to claim 1, wherein the head includes at least three outer flat surfaces that are flat and constitute an outer surface.

8. The wrench according to claim 1, wherein an outer surface of a neck connecting the head and the handle is a surface parallel to a rotation axis of the head.
